(19) United States
(12) Patent Application Publication
(10) Pub. No.: US 2005/0002731 A1
(43) Pub. Date: Jan. 6, 2005

(54) Fastening element and fastening system for plastic containers

(76) Inventors: Bernhard Beer, Waldbrol (DE); Burghard Hilse-Langen, Giesenhausen (DE)

Correspondence Address: SUTHERLAND ASBILL & BRENNAN LLP, 999 PEACHTREE STREET, N.E., ATLANTA, GA, 30309, US

(21) Appl. No.: 10/823,876

(22) Filed: Apr. 14, 2004

Related U.S. Application Data
(60) Provisional application No. 60/541,088, filed on Feb. 2, 2004.

(30) Foreign Application Priority Data
Apr. 16, 2003 (DE) 103 17 484.2

(51) Int. Cl. F16B 1/00

(52) U.S. Cl. 403/294

(57) ABSTRACT

The present invention relates to a fastening element for plastic containers, comprising a plurality of first bushings interconnected by connecting bridges, and to a fastening system for liquid-proof flanging or attachment of plastic containers for liquids, said fastening system comprising a fastening element having a plurality of first bushings, interconnected by connecting bridges, and a flange.

### CROSS REFERENCE TO RELATED APPLICATIONS

This application claims priority to German Application No. DE103 17 484.2 filed Apr. 16, 2003 and U.S. Provisional Application Ser. No. 60/541,088 filed Feb. 2, 2004.

### TECHNICAL FIELD OF THE INVENTION

The present invention relates to a fastening element for plastic containers, to a plastic container for liquids, and to a fastening system for liquid-proof flanging or attachment of plastic containers for liquids, comprising the fastening element according to the invention.

### BACKGROUND OF THE INVENTION

According to the prior art, containers such as engine oil pans, transmission oil pans, or containers in washing machines, dish washers, and water-heaters, which containers are used to receive liquids, are normally integrated into the corresponding device or corresponding apparatus as follows: a flange is formed along the periphery of the opening of the corresponding container, which flange comprises bores or through-holes having metal bushings inserted therein, into which screws are introduced in turn to screw the container onto the counterpart. A seal is arranged between the top side of the flange and the counterpart.

As a result of the leakproofness requirements, a large number of screw-on points are necessary, correspondingly using a multitude of bushings and screws. Disadvantageously, the bushings and screws, as well as the corresponding assembly devices, are costly and expensive and also, the time periods for assembly are long.

Furthermore, as a result of forces acting in the area of the bushing following attachment, the plastic material of the container undergoes high strain, so that many screw-on points are required in order to achieve liquidproofness. The rigidity of the construction depends on the modulus of elasticity (Young's modulus) of the material that is used and also to a large degree on the temperature during use.

The art has seen attempts to reduce the number of screw-on points and reduce the strain of the plastic container in the area of the screw-on points by employing a hybrid technology in the production of the plastic containers, wherein simple sheet metal supports are partially or completely plastic-coated by spraying to obtain a composite, the sheet metal supports being integrated in the plastic container.

However, component parts holding liquids are disadvantageous in that such hybrid components become leaky. Such problems may arise because the sheet metal during the production process permeates the wall of the container, thus giving rise to such a defect during use, e.g. by formation of capillaries permeable to liquids.

Furthermore, plastic hybrid containers with integrated sheet metal supports are disadvantageous in that massive deformation and thus leakage and therefore failure of such a component part may arise as a result of dissimilar thermal expansion coefficients of the materials. Obviously, these problems are increased in those devices, e.g. oil pans, wherein the temperature is subject to strong variations.

In view of this state of the art the technical object was therefore to develop fastening elements, plastic containers and fastening systems adjusted to each other, allowing reduction of the number of screw-on points without jeopardizing the leakproofness.

### SUMMARY OF THE INVENTION

The technical object is accomplished by means of a fastening element 1 for plastic containers 6, said fastening element comprising a plurality of first bushings 3 interconnected by connecting bridges 2.

Furthermore, the invention is accomplished by means of a plastic container 6 for liquids, with an opening 7, a flange 8 being formed along at least a portion of the periphery of the opening, said flange 8 having recesses extending through the thickness of the flange to accommodate said first bushings 3 of the fastening element, the connecting bridge 2 or the metal sheet 2a of the fastening element making accurately fitting and positive contact at the lower edge of the flange 8 following attachment of the fastening element 1 to the plastic container 6. Preferably, said plastic container is an engine oil pan or a transmission oil pan.

Further, the technical object is accomplished by means of a fastening system for liquid-proof flanging or attachment of plastic containers 6 for liquids, said fastening system comprising a fastening element having a plurality of first bushings 3, interconnected by connecting bridges 2, and a flange 8. More specifically, preferred embodiments of the fastening system are represented by the above-described preferred designs of the fastening element.

Furthermore, the technical object is accomplished by means of a fastening system comprising at least one fastening element and separate bushings, the bushings having a widened portion on the outside thereof, the bushings allowing accurately fitting and positive insertion thereof into the bushing-receiving elements of the fastening element, and the widened portion of the bushings preventing slipping of the bushings through the bushing-receiving elements of the fastening element.

### BRIEF DESCRIPTION OF THE DRAWINGS

FIG. 1 shows the inventive fastening element 1 having first bushings 3 permanently affixed thereon.

FIG. 2 shows a view of a plastic container 6 for liquids, with the fastening element 1 arranged thereon.

FIG. 3 shows a perspective view of the plastic container 6 of FIG. 2, showing the lower edge of plastic flange 8.

FIG. 4 shows the inventive fastening element 1, with additional elements 4 for fastening other component parts being arranged thereon.

FIG. 5 shows the inventive fastening element of FIG. 4 with a plastic container.

FIG. 6 shows a preferred embodiment of the fastening element according to the invention.

FIG. 7 shows a detail view of the fastening element of FIG. 6.

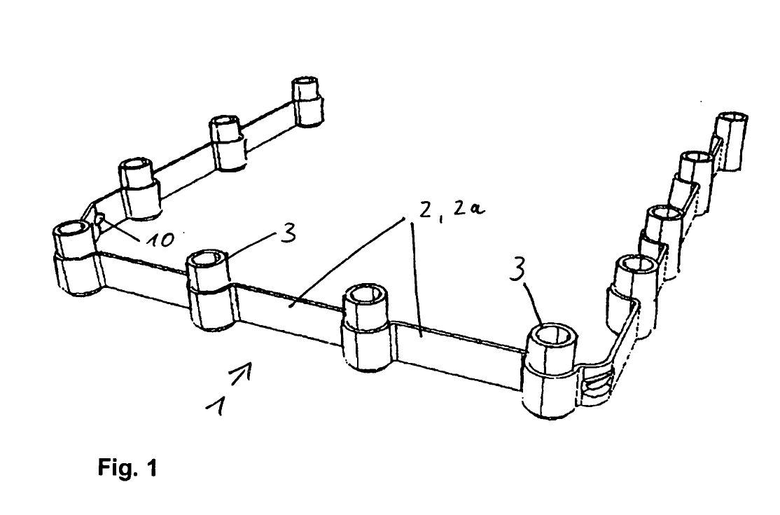

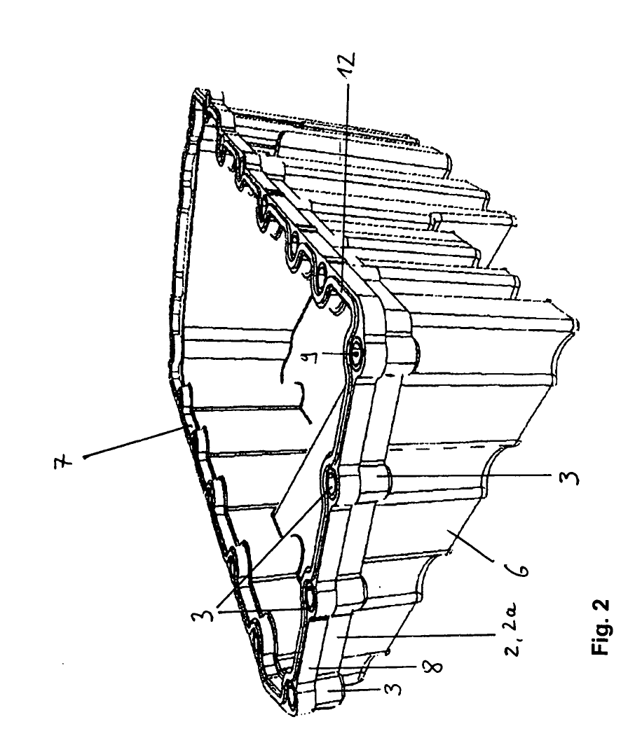

FIG. 1 shows the inventive fastening element 1 having first bushings 3 permanently affixed thereon. The fastening element essentially follows at least a portion of the contour of the open region of the plastic oil pan (FIG. 2). For further reinforcement of the fastening element, beads 10 are arranged at the bend points or angles. The portion of the bushings 3 protruding beyond the (upper) edge of the connecting bridge 2 or metal sheet 2a is inserted into the bores of the plastic flange 8 of the plastic container 6 as shown in FIG. 2.

FIG. 2 shows a view of a plastic container 6 for liquids (in this case an oil pan for engines), with a plastic flange 8 being formed along the periphery or contour of the opening 7 or open region of the plastic container or plastic oil pan. The plastic flange 8 has holes or through-bores 9 into which the first bushings 3 of the inventive fastening element 1 (from FIG. 1) are introduced. The upper edge of each bushing 3 inserted into the bores 9 of the plastic flange 8 can be seen in this view. The fastening element also has connecting bridges 2, 2a between the bushings 3 and is arranged with one (namely, the upper) edge of the metal sheet at the lower edge of the plastic flange 8. The (upper) edge of the metal sheet 2a of the fastening element 1 contacts the lower edge of the plastic flange. In this way, the screw-on forces and screw-on torques radiating from the bushings (once the plastic container is attached to the counterpart) are distributed uniformly across the flange via the connecting bridges between the bushings.

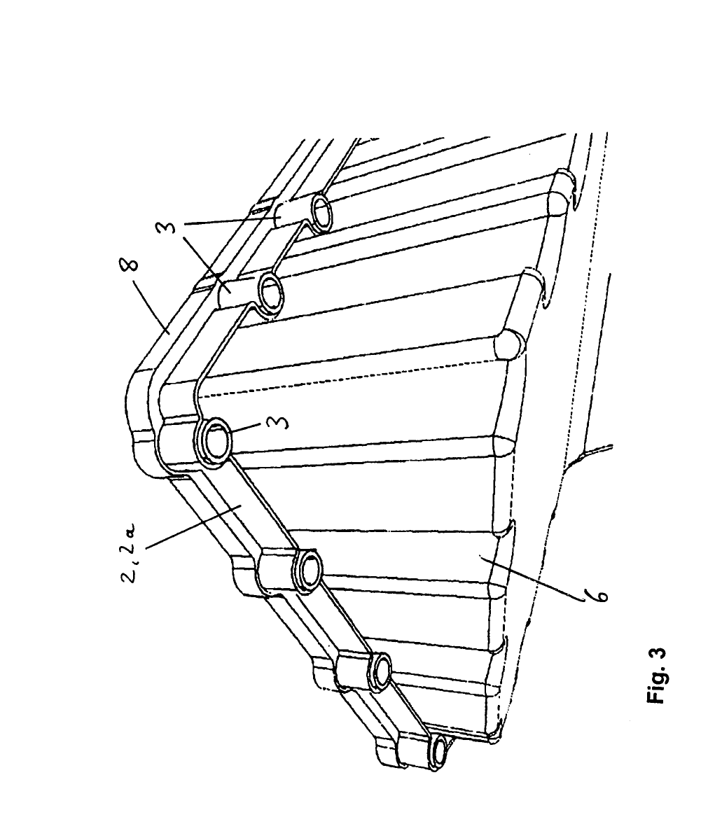

FIG. 3 shows a perspective view of the plastic container 6 of FIG. 2, showing the lower edge of plastic flange 8, the fastening element 1 with a metal sheet 2a with metal bushings 3 welded thereon being attached thereto. This view clearly shows that in a preferred embodiment of the fastening element the metal sheet is continuous, and bulges to receive the bushings are formed at those positions in the metal sheet where the bushings are attached.

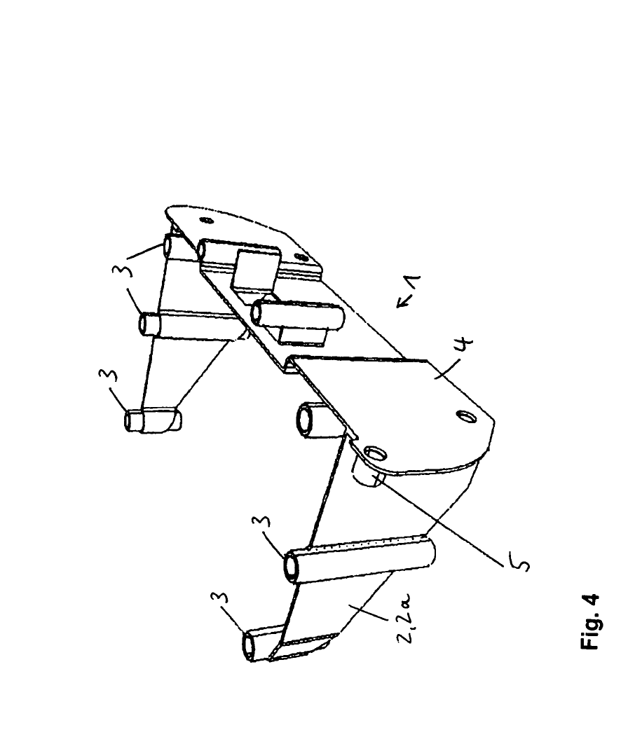

FIG. 4 shows the inventive fastening element 1 with permanently arranged first bushings 3, with additional elements 4 for fastening other component parts being arranged thereon. Also, the second bushings 5 can be seen therein.

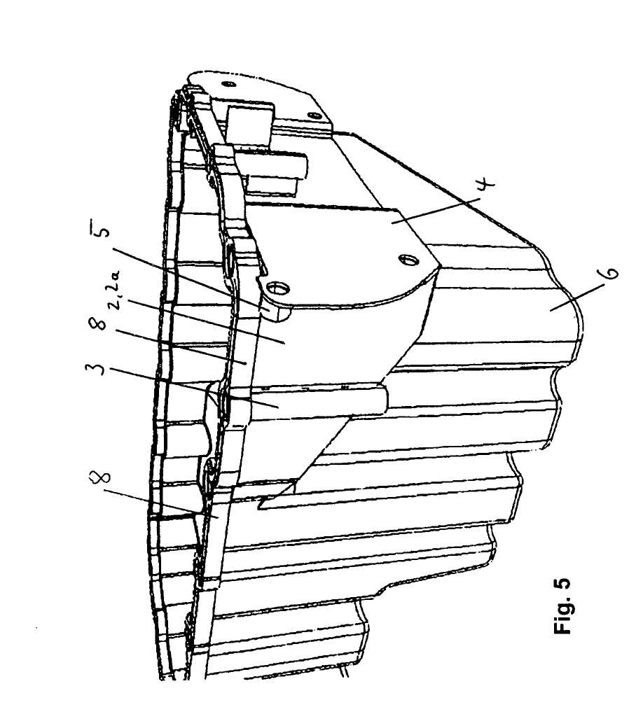

FIG. 5 shows the inventive fastening element of FIG. 4, attached to the plastic container 6 in a corresponding fashion.

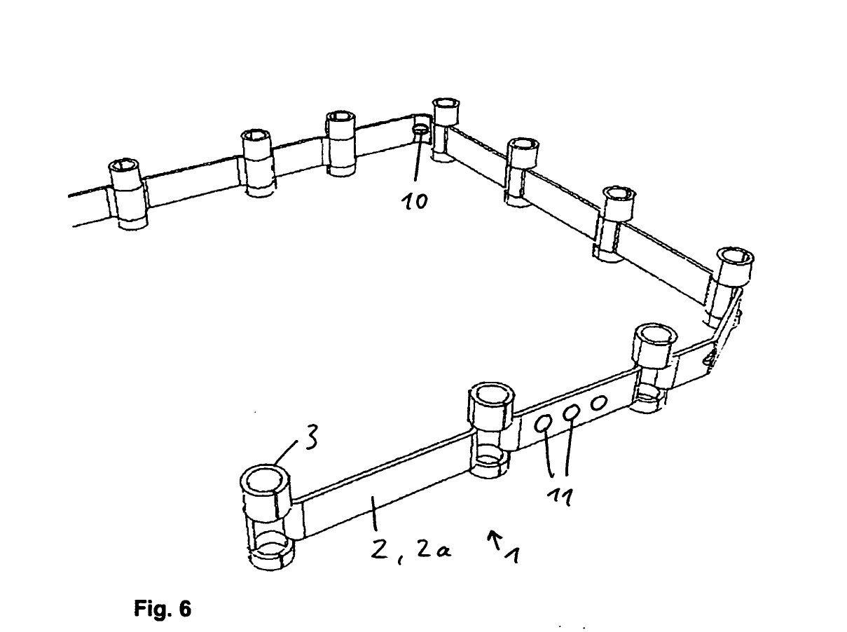

FIG. 6 shows a preferred embodiment of the fastening element 1 according to the invention. In this case the fastening element is made of a single piece, i.e. of a metal sheet. The sheet metal has been bent and cut in such a way that the sections of the bushing portion protruding beyond the edges of the connecting bridge of the sheet metal form an essentially complete circle. The other section of the bushing portion essentially represents an approximately half circle. FIG. 6 also depicts the beads 10 and the holes 11 in the connecting bridges for weight reduction.

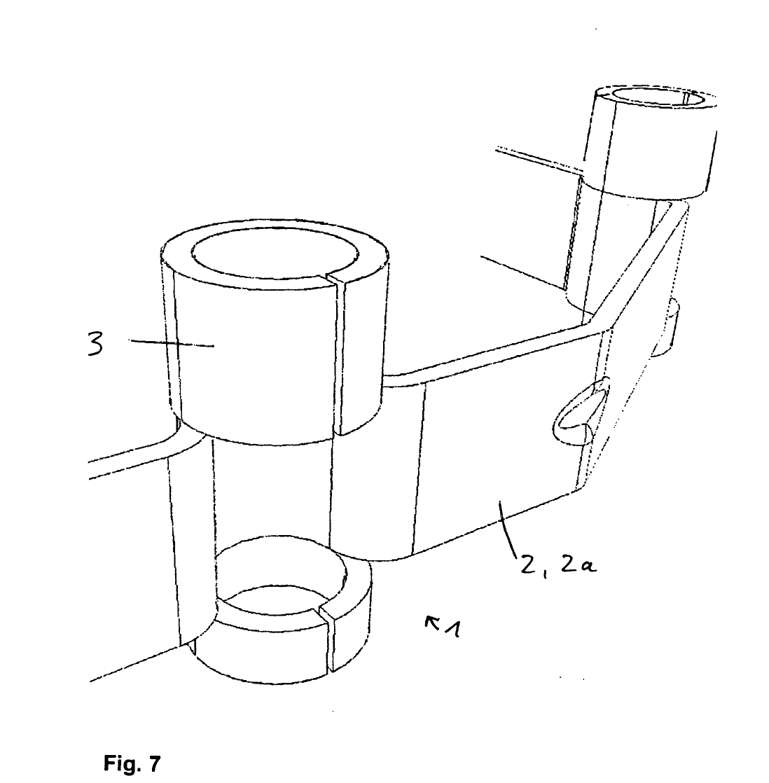

FIG. 7 shows a detail view of the fastening element of FIG. 6, wherein the formation of bushings from the sheet metal can be seen.

### DETAILED DESCRIPTION OF THE INVENTION

According to the present invention, a fastening element is provided which comprises bushings and is arranged on the flange of the opening or open region of the plastic container in such a way that the bushings of the fastening element are introduced through the recesses or holes of the flange from below, so that the connecting bridges of the fastening element make accurately fitting and positive contact at the lower edge of the flange. Fastening of the plastic container, e.g. of an oil pan to an engine block, is effected by screwing, the screws being introduced into the bushings and screwed into the counterpart. The fastening element is advantageous in that the forces radiating from the screw-on points during or after screwing on are distributed uniformly across the entire flange of the plastic container via the connecting bridges between the bushings. In this way, some areas of the plastic part undergo less strain, and the number of screw-on points can be reduced, with no problems with respect to leakproofness arising.

In a preferred embodiment the bushings 3 are made of the same material as the connecting bridges 2 connecting the bushings.

Furthermore, the bushings 3 and the connecting bridges 2 are preferably made of metal, preferably steel. In one alternative the connecting bridges 2 and the connecting bridges 2 are made of a cast metal, preferably cast iron, cast aluminum or cast magnesium. Particularly preferred the bushings 3 and the connecting bridges 2 are made of die cast aluminum. Further preferred the fastening element is formed as a single piece.

In a particularly preferred embodiment the first bushings 3 and the connecting bridges 2 are made of metal, preferably steel. In a particularly preferred fashion the fastening element is formed as a single piece. This embodiment is illustrated in FIGS. 6 and 7. Here, the connecting bridges and the bushings are made of a sheet metal. In an alternative embodiment the first bushings 3 and the connecting bridges 2 are joined by welding. In a preferred embodiment the metal sheet is continuous, bulges to receive the bushings being formed at those positions in the metal sheet where the bushings are attached. In another preferred embodiment the connecting bridges of the fastening element are provided with holes 11 so as to reduce the weight (FIG. 6).

Furthermore, in a particularly preferred fashion the connecting bridges 2 are in the form of a metal sheet 2a. Each connecting bridge of metal sheet, i.e., the sheet metal strip, now situated between the screw-on points, exerts the required pressure on the plastic flange, thus stabilizing the system. Such a substantially higher stability is achieved because a metal sheet has considerably higher rigidity (Young's modulus: 210,000 N/mm²) compared to plastic. Thus, for example, a fiberglass-reinforced PA (polyamide) plastic material has a modulus of elasticity of about 7,000 N/mm² at 20° C. Also in the embodiment wherein the fastening element is made of a cast metal a higher rigidity compared to plastic is achieved.

Preferably, the width of the metal sheet of the fastening element is essentially parallel to the longitudinal axes of the first bushings. In such an arrangement only one edge of the metal sheet contacts the bottom surface of the plastic flange, thereby achieving immense stability of the system. This also does apply to the embodiment wherein the fastening element is made of a cast metal. Also in this case the width of the connecting bridge preferably is essentially parallel to the longitudinal axes of the first bushings. Also in this arrangement only one edge of the connecting bridge contacts the bottom surface of the plastic flange, thereby achieving immense stability of the system.

In another preferred embodiment the metal sheet is beaded or has an L-shaped cross-section. Such beading enlarges the contact surface of the metal sheet at the lower edge of the flange, resulting in a greater distribution of the screwing forces and screwing torques. This also does apply to the embodiment wherein the fastening element is made of a cast metal. Also in this embodiment the connecting bridge preferably is beaded or has an L-shaped cross-section.

In another preferred embodiment the fastening element has additional elements 4 with fastening function arranged thereon, with second bushings 5 preferably being arranged on said additional elements 4. This embodiment enables the use of the inventive fastening element in positions where e.g. additional forces have to be introduced. For example, this can be flanging of additional units, e.g. flanging of the transmission housing to the engine housing.

The fastening element of the invention follows the contour of the opening of the plastic container, which is why the regions or connecting bridges connecting the bushings are angled or bent in particular positions. To increase the rigidity of the component parts, beads 10 or angles are preferably arranged in these bend points.

In a preferred embodiment the plastic container according to the invention is an oil pan or a transmission oil pan.

Furthermore, the invention provides a fastening system for liquid-proof flanging or attachment of plastic containers 6 for liquids, said fastening system comprising a fastening element having a plurality of first bushings 3, interconnected by connecting bridges 2, and a flange 8. More specifically, preferred embodiments of the fastening system are represented by the above-described preferred designs of the fastening element.

In the fastening system according to the invention, said flange 8 preferably is arranged along at least a portion of the periphery of an opening 7 of the plastic container 6. In another preferred embodiment the flange 8 has recesses 9 extending through the thickness of the flange to accommodate said first bushings 3 of the fastening element 1. The recesses are preferably through-holes or bores.

Following attachment of the fastening element 1 to the plastic container 6, the connecting bridge 2 of the fastening element 1 preferably makes accurately fitting and positive contact at the lower edge of the flange 8.

The bushings 3 are preferably made of the same material as the connecting bridges 2 connecting the bushings. In a likewise preferred fashion the bushings 3 and the connecting bridges 2 are made of metal, preferably steel. In a particularly preferred fashion the fastening element is formed as a single piece. This embodiment is illustrated in FIGS. 6 and 7. Here, the connecting bridges and the bushings are made of a sheet metal. In one alternative the bushings 3 and connecting bridges 2 are made of a cast metal, preferably cast iron, cast aluminum or cast magnesium, especially preferred die cast aluminum. Also in the embodiment made of a cast metal the fastening element preferably is formed as a single piece. In a particularly preferred fashion the first bushings 3 and the connecting bridges 2 are made of metal, preferably steel, and preferably joined by welding. Furthermore, the connecting bridges 2 are preferably formed as metal sheet 2a, preferably sheet steel. In a preferred embodiment the metal sheet is continuous, bulges to receive the bushings being formed at those positions in the metal sheet where the bushings are attached. In another preferred embodiment the connecting bridges of the fastening element are provided with holes 11 so as to reduce the weight (FIG. 6).

In another embodiment the width of the metal sheet is oriented essentially parallel to the longitudinal axes of the first bushings 3. This also does apply to the embodiment wherein the fastening element is made of a cast metal. Also in this case the width of the connecting bridge is essentially parallel to the longitudinal axes of the first bushings. Also in this arrangement only one edge of the metal sheet contacts the bottom surface of the plastic flange, thereby achieving immense stability of the system.

In a preferred fashion the metal sheet 2 is beaded or has an L-shaped cross-section. In another preferred embodiment additional elements 4 with fastening function are provided, and in a particularly preferred fashion second bushings 5 are arranged on said additional elements 4. This also does apply to the embodiment wherein the fastening element is made of a cast metal. Also in this case the connecting bridge is beaded or has an L-shaped cross-section.

The plastic container is preferably an engine oil pan or a transmission oil pan.

According to the invention, there is also provided a fastening element for liquidproof fastening of plastic containers for liquids to other component parts, the fastening element being present in the form of a support or connecting bridge to receive and arrange a plurality of first bushings, the fastening element comprising bushing-receiving elements allowing insertion of bushings, the fastening element being adapted so as to make accurately fitting and positive contact at the lower edge of a flange of an opening of the plastic container after attachment, the fastening element allowing insertion of bushings into bushing-receiving elements of the fastening element and thereafter into bushing-receiving elements of the flange.

The bushing-receiving elements of the fastening element are preferably throughholes or at least partial enclosures.

In a likewise preferred fashion, the fastening element is made of a metal, preferably steel. In one alternative the fastening element is made of a cast metal, preferably cast iron, cast aluminum or cast magnesium, especially preferred die cast aluminum. Also in the embodiment made of a cast metal the fastening element is formed as a single piece. Furthermore, the connecting bridges 2 are preferably formed as metal sheet 2a, preferably sheet steel. In a preferred embodiment the metal sheet is continuous, bulges to receive the bushings being formed at those positions in the metal sheet where the bushings are attached. In another preferred embodiment the connecting bridges of the fastening element are provided with holes 11 so as to reduce the weight.

In another particularly preferred embodiment the width of the metal sheet is essentially parallel to the longitudinal axes of the first bushing-receiving elements. This does also apply to the embodiment made of a cast metal. Also in this case the width of the metal sheet preferably is essentially parallel to the longitudinal axes of the first bushing-receiving elements. Also in this arrangement only one edge of the connecting bridge contacts the bottom surface of the plastic flange.

The metal sheet is preferably beaded or has an L-shaped cross-section. This does also apply to the embodiment made of a cast metal. Also in this case the connecting bridge preferably is beaded or has an L-shaped cross-section.

In another particularly preferred embodiment the fastening element has additional elements with fastening function arranged thereon, with second bushings preferably being arranged on said additional elements.

Furthermore, the invention provides a fastening system comprising at least one fastening element and separate bushings, the bushings having a widened portion on the outside thereof, the bushings allowing accurately fitting and positive insertion thereof into the bushing-receiving elements of the fastening element, and the widened portion of the bushings preventing slipping of the bushings through the bushing-receiving elements of the fastening element.

According to this embodiment, the fastening element and the bushings can be present separately and adjusted to each other in such a way that, according to the invention, they can be used as a fastening element having permanently arranged bushings thereon to fasten plastic containers.

One advantage offered by the present invention is that the plastic containers are considerably reduced in weight as a result of using a smaller number of bushings and screws. Moreover, the smaller number of fastening points is more favorable in cost compared to prior art designs where larger numbers of screw-on points must be provided and the bushings are not connected to each other, and if so, not by additional rigidity elements.

Another advantage resulting from the smaller number of screw-on points is improved acoustic decoupling. It is also advantageous that the separate flange used to fix additional units results in improved acoustic decoupling. In addition, advantages result from the fact that when changing the plastic container for liquids, e.g. the oil pan, the corresponding flange region is independent, i.e., does not have to be changed. Moreover, the cost of assembly is more favorable because the fastening element of the invention has the bushings already integrated therein and the fastening element of the invention can be mounted in a single operation.

The subject matter of the present invention will be exemplified with reference to the following description of the Figures. However, the Examples and Figures illustrated herein are merely intended to explain the invention and do not limit the subject matter thereof.

1. A fastening element for plastic containers, said fastening element comprising a plurality of first bushings interconnected by connecting bridges.

2. The fastening element of claim 1, wherein the bushings are made of the same material as the connecting bridges connecting the bushings.

3. The fastening element of claim 1, wherein the bushings and connecting bridges are made of metal, steel, cast metal, cast iron, cast aluminum or cast magnesium.

4. The fastening element of claim 1, wherein the first bushings and the connecting bridges are made of metal or steel, and the fastening element is formed as a single piece, or the first bushings and the connecting bridges are joined by welding.

5. The fastening element of claim 1, wherein the connecting bridges are formed as a metal sheet.

6. The fastening element of claim 1, wherein the connecting bridges have holes.

7. The fastening element of claim 5, wherein the width of the metal sheet is essentially parallel to the longitudinal axes of the first bushings.

8. The fastening element of claim 5, wherein the metal sheet is beaded or has an L-shaped cross-section.

9. The fastening element of claim 1, wherein additional elements with fastening function are arranged thereon, with second bushings being arranged on said additional elements.

10. A plastic container for liquids coprising an opening, a flange being formed along at least a portion of the periphery of the opening, said flange having recesses extending through the thickness of the flange to accommodate said first bushings of the fastening element according to claim 1, said connecting bridge or metal sheet of the fastening element making accurately fitting and positive contact at the lower edge of the flange following attachment of the fastening element to the plastic container.

11. The plastic container of claim 10, wherein said plastic container is an engine oil pan or a transmission oil pan.

12. A fastening system for liquid-proof flanging or attachment of plastic containers for liquids, said fastening system comprising a fastening element having a plurality of first bushings, interconnected by connecting bridges, and a flange.

13. The fastening system of claim 12, wherein the flange is arranged along at least a portion of the periphery of an opening of the plastic container.

14. The fastening system of claim 12, wherein the flange has recesses extending through the thickness of the flange to accommodate said first bushings of the fastening element.

15. The fastening system of claim 12, wherein following attachment of the fastening element to the plastic container, the connecting bridge of the fastening element makes accurately fitting and positive contact at the lower edge of the flange.

16. The fastening system of claim 12, wherein the bushings are made of the same material as the connecting bridges connecting the bushings.

17. The fastening system of claim 12, wherein the bushings and the connecting bridges are made of metal, steel, cast metal, cast iron, cast aluminum or cast magnesium.

18. The fastening system of claim 12, wherein the first bushings and the connecting bridges are made of metal, preferably steel, and that the fastening element is formed as a single piece, or the first bushings and the connecting bridges are joined by welding.

19. The fastening system of claim 12, wherein the connecting bridges are in the form of a metal sheet or sheet steel.

20. The fastening system of claim 12, wherein the connecting bridges have holes.

21. The fastening system of claim 19, wherein the width of the metal sheet is essentially parallel to the longitudinal axes of the first bushings.

22. The fastening system of claim 19, wherein the metal sheet is beaded or has an L-shaped cross-section.

23. The fastening system of claim 12, wherein additional elements with fastening function are arranged thereon, with second bushings preferably being arranged on said additional elements.

24. The fastening system of claim 12, wherein the plastic container is an engine oil pan or a transmission oil pan.

25. A fastening element for liquid-proof fastening of plastic containers for liquids to other component parts, the fastening element being present in the form of a support or connecting bridge to receive and arrange a plurality of first bushings, the fastening element comprising bushing-receiving elements allowing insertion of bushings, the fastening element being adapted so as to make accurately filting and positive contact at the lower edge of a flange of an opening of the plastic container after attachment, the fastening element allowing insertion of bushings into bushing-receiving elements of the fastening element and thereafter into bushing-receiving elements of the flange.

26. The fastening element of claim 25, wherein the bushing-receiving elements of the fastening element are through-holes or at least partial enclosures.

27. The fastening element of claim 25, wherein the fastening element is made of metal, steel, cast metal, cast iron, cast aluminum or cast magnesium.

28. The fastening element of claim 25, wherein the fastening element is in the form of a metal sheet or sheet steel.

29. The fastening element of claim 25, wherein the connecting bridges have holes.

30. The fastening of claim 28, wherein the width of the metal sheet is essentially parallel to the longitudinal axes of the first bushing-receiving elements.

31. The fastening element of claim 28, wherein the metal sheet is beaded or has an L-shaped cross-section.

32. The fastening element of claim 25, wherein additional elements with fastening function are arranged thereon, with second bushings preferably being arranged on said additional elements.

33. A fastening system comprising at least one fastening element according to claim and bushings having a widened portion on the outside thereof, the bushings allowing accurately fitting and positive insertion thereof into the bushing-receiving elements of the fastening element, and the widened portion of the bushings preventing slipping of the bushings through the bushing-receiving elements of the fastening element.
